(19) United States
(12) Patent Application Publication
(10) Pub. No.: US 2009/0246426 A1
(43) Pub. Date: Oct. 1, 2009

(54) FIRE RESISTANT GLAZING ASSEMBLY WITH ADDITIONAL FUNCTIONS

(76) Inventor: Haijiang Wu, Toronto (CA)

Correspondence Address: MR. HAIJIANG WU, 31 GRASS MEADOWAY, TORONTO, ON, M2H 2V4, CA

(21) Appl. No.: 12/411,374

(22) Filed: Mar. 25, 2009

Related U.S. Application Data
(60) Provisional application No. 61/040,488, filed on Mar. 28, 2008.

(51) Int. Cl. E06B 3/00

(52) U.S. Cl. 428/34

(57) ABSTRACT

A fire resistant glazing assembly with various additional functions in impact safety, solar control, bullet and blast resistance, burglary and forced entry resistance, natural disaster protection, decoration and aesthetics, privacy protection, sound insulation and signal defense security. The fire resistant glazing assembly comprises: (a) two or more glass sheets that are parallel and spaced-apart from each other, the distance between any two adjacent glass sheets is from 1 mm to 40 mm; (b) one plastic film that is adhered onto one of opposite surfaces of the glass sheets or more plastic films that are respectively adhered onto more opposite surfaces of the glass sheets; (c) one or more intumescent interlayers that are between the glass sheets and bond with the glass sheet or the plastic film adhered onto the glass sheet. The fire resistant glazing assembly achieves various additional functions by means of different plastic films existing inside the glazing assembly. The adopted plastic film is compatible with fire resistant glazing assembly and has at least one specific function in safety and security, solar control, decoration and aesthetics, privacy protection, sound insulation and signal defense security.

### RELATED APPLICATION

This application claims priority under U.S.C. 119(e) to U.S. Provisional Patent Application Ser. No. 61/040,488, filed Mar. 28, 2008, incorporated herein by reference.

### BACKGROUND OF THE INVENTION

1. Field of the Invention

The present invention relates to a fire resistant glazing assembly with various additional functions in impact safety, solar control, bullet and blast resistance, burglary and forced entry resistance, natural disaster protection, decoration and aesthetics, privacy protection, sound insulation and signal defense security.

2. Description of the Related Art

Fire resistant glazing assemblies have been widely used in the world for many years. Although there are some differences among these products, generally fire resistant glazing assemblies are made of glass sheets and intumescent interlayers in sandwich form: two or more glass sheets are arranged in parallel and spaced apart from each other; intumescent interlayers are between the glass sheets; the glass sheets and intumescent interlayers bond together and compose a glazing assembly with fire resistance function. Depending upon different fire resistance rating, fire resistant glazing assemblies have different number and thickness of intumescent interlayers.

As the special glazing materials used in fire-rated doors, windows, partitions and other fire-rated structures, in many circumstances fire resistant glazing assemblies need to have various additional functions beyond fire resistance, such as the functions in impact safety, sound insulation, bullet and blast resistance, etc.

According to prior art, some fire resistant glazing assemblies are made by laminating many pieces of float glass sheets together; some others are made of tempered glass sheets, laminated glass sheets or strengthened glass sheets. So, it is imaginable for these products to have the additional functions in impact safety, security and even bullet or blast resistance; but it is difficult for these products to achieve the additional functions in many other aspects.

Some fire resistant glazing assemblies achieve certain additional functions with the help of surface-applied films; however surface-applied films are easy to be damaged or defaced in real applications. So the durability is a big problem for these products.

Some fire resistant glazing assemblies achieve certain additional functions by integrating them with one or more pieces of other glazing materials having certain special functions. It is a feasible way but usually causes the finished glazing assemblies to be thick, heavy and expensive.

### SUMMARY OF THE INVENTION

The objective of the present invention is to provide a fire resistant glazing assembly which is able to have various additional functions in impact safety, solar control, bullet and blast resistance, burglary and forced entry resistance, natural disaster protection, decoration and aesthetics, privacy protection, sound insulation and signal defense security, and at the same time has advantages in applicability, durability, thickness, weight and cost.

According to the present invention, the objective and advantages are achieved by making fire resistant glazing assembly with glass sheets, intumescent interlayer(s) and plastic film(s) having certain specific functions. The fire resistant glazing assembly with additional functions comprises:

(a) two or more glass sheets that are parallel and spaced-apart from each other, the distance between any two adjacent glass sheets is from 1 mm to 40 mm;

(b) one plastic film that is adhered onto one of opposite surfaces of the glass sheets or more plastic films that are respectively adhered onto more opposite surfaces of the glass sheets; and

(c) one or more intumescent interlayers that are between the glass sheets and bond with the glass sheet or the plastic film adhered onto the glass sheet.

According to further aspect of the present invention, the glass sheets and plastic films are selected and applied as following:

The glass sheets adopt soda-lime glass sheets, which can be annealed, tinted, tempered, strengthened or laminated glass sheets, and whose surfaces can be original, coated, patterned, painted, etched, or sandblasted.

The plastic films adopt either commercialized window films or original plastic films; commercialized window films are the first choice. The chosen plastic films are compatible with fire resistant glazing assembly and have the specific functions that help the glazing assembly to achieve the expected additional functions. The chosen plastic films have at least one specific function in safety and security, solar control, decoration and aesthetics, privacy protection, sound insulation and signal defense security. While two or more plastic films are being applied in a fire resistant glazing assembly, they can be either the same film or different films.

The adhesive is used to stick the plastic film onto surface of the glass sheet. Acrylic adhesive or silicone adhesive is appropriate for this purpose.

The surface treatment techniques such as coating, chemical grafting and corona discharging are used to treat the surface of the plastic film in order to improve the adhesion between plastic film and intumescent interlayer.

The process of manufacturing the fire resistant glazing assembly with additional functions comprises the steps of: adhering the plastic film(s) onto surface(s) of the glass sheet(s) firstly, and then bonding the glass sheets and intumescent interlayer(s) together in accordance with the specific method of the intumescent interlayer material used.

### BRIEF DESCRIPTION OF THE DRAWINGS

The present invention will be described in more detail hereinafter by means of the preferred embodiments with reference to the following figures:

FIG. 1 is a cross-sectional view of an embodiment that has a symmetrical structure containing two glass sheets, two plastic films and one intumescent interlayer.

FIG. 2 is a cross-sectional view of an embodiment that has a symmetrical structure containing three glass sheets, two plastic films and two intumescent interlayers.

FIG. 3 is a cross-sectional view of an embodiment that has an unsymmetrical structure containing two glass sheets, one plastic film and one intumescent interlayer.

FIG. 4 is a cross-sectional view of an embodiment that has an unsymmetrical structure containing three glass sheets, one plastic film and two intumescent interlayers.

FIG. 5 is a cross-sectional view of an embodiment that has a symmetrical structure containing three glass sheets, four plastic films and two intumescent interlayers.

### DETAILED DESCRIPTION OF THE PREFERRED EMBODIMENTS

FIG. 1 depicts an embodiment that has a symmetrical structure containing two glass sheets, two plastic films and one intumescent interlayer. Material 1 and 2 are soda-lime glass sheets. Material 3 and 4 are plastic films having certain specific functions; they are respectively adhered onto the opposite surfaces of glass sheet 1 and 2. Material 5 is an intumescent interlayer; it is between glass sheet 1 and 2, and bonds with plastic film 3 and 4.

Material 3 and 4 are plastic films having certain specific functions. They are respectively adhered onto the two opposite surfaces of glass sheet 1 and 2; thus they bring the specific functions to glass sheet 1 and 2 so that the glazing assembly made with the glass sheet 1 and 2 obtains the same specific functions. For example: when plastic film 3 and 4 adopt safety or security window films, they bring the glazing assembly the additional functions in impact safety, natural disaster protection, and burglary and forced entry resistance; when one of them adopts decorative window film and another adopts safety window film, they bring the glazing assembly the additional functions in decoration and impact safety; when one or both of them adopt signal defense security window films, they bring the glazing assembly the additional function in signal defense security.

Under normal circumstances, intumescent interlayer 5 bonds with plastic film 3 and 4 firmly so that all the materials compose a glazing assembly. In case of fire, the glass sheet on fire side will crack firstly, the plastic film adhered onto this glass sheet will melt in several minutes; then the cracked glass will fall and the plastic film will flame up. At that time, the intumescent interlayer will begin to foam; gradually the intumescent interlayer will form a heat-insulated barrier, which retards flame and heat to transfer to non-fire side. For this reason, within a certain period, the plastic film adhered onto the glass sheet on non-fire side can still bond with the glass sheet well; non-fire side of the glazing assembly can still keep integrity and lower temperature. Obviously, the thicker intumescent interlayer is, the longer fire resistance period achieves.

### EXAMPLE 1

A glazing assembly was made in accordance with FIG. 1. Material 1 and 2 were two pieces of 4 mm soda-lime float glass. Material 3 and 4 were two pieces of 0.1 mm safety window films. Material 5 was a 5 mm hydrogel intumescent interlayer. The glazing assembly achieved more than 20 minutes fire integrity, and could withstand a 400 ft-lb impact on any side of the glazing assembly.

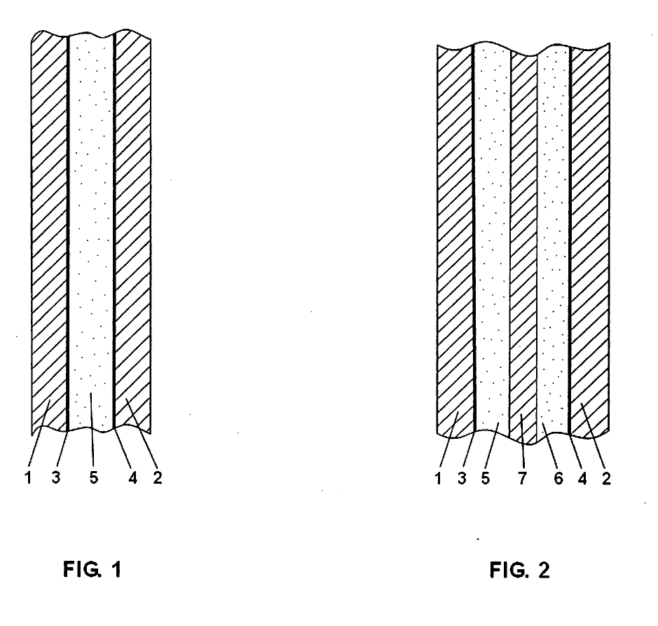

FIG. 2 depicts an embodiment that has a symmetrical structure containing three glass sheets, two plastic films and two intumescent interlayers. Material 1, 2 and 7 are soda-lime glass sheets. Material 3 and 4 are plastic films having certain specific functions; they are respectively adhered onto the opposite surfaces of glass sheet 1 and 2. Material 5 is an intumescent interlayer; it is between glass sheet 1 and 7, and bonds with plastic film 3 and glass sheet 7. Material 6 is another intumescent interlayer; it is between glass sheet 2 and 7, and bonds with plastic film 4 and glass sheet 7.

This embodiment is a complication of the embodiment depicted in FIG. 1; it has the two intumescent interlayers. The further complication can have more intumescent interlayers.

### EXAMPLE 2

A glazing assembly was made in accordance with FIG. 2. Material 1 and 2 were two pieces of 4 mm soda-lime float glass; material 7 was a piece of 3 mm soda-lime float glass. Material 3 and 4 were two pieces of 0.05 mm safety window films. Material 5 and 6 were 5 mm hydrogel intumescent interlayers. The glazing assembly achieved 30 minutes fire insulation and more than 45 minutes fire integrity, and could withstand a 400 ft-lb impact on any side of the glazing assembly.

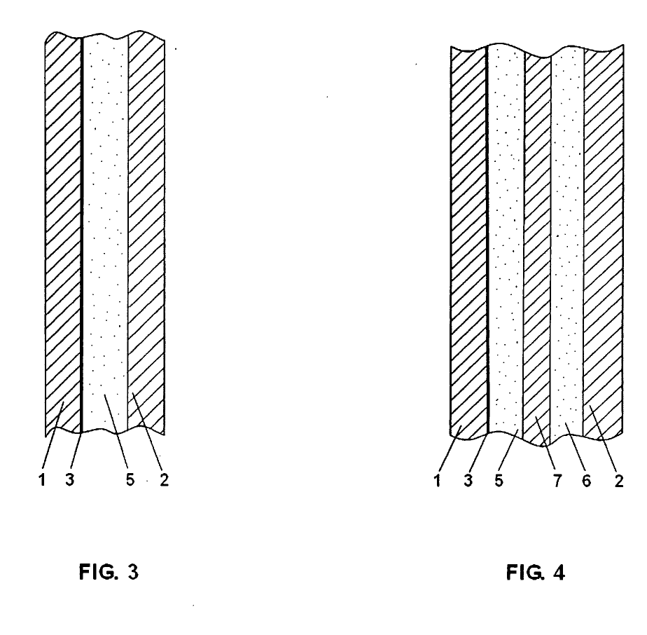

FIG. 3 depicts an embodiment that has an unsymmetrical structure containing two glass sheets, one plastic film and one intumescent interlayer. Material 1 and 2 are soda-lime glass sheets. Material 3 is plastic film having certain specific functions; it is adhered onto the surface of glass sheet 1. Material 5 is an intumescent interlayer; it is between glass sheet 1 and 2, and bonds with plastic film 3 and glass sheet 2.

This embodiment is especially suitable for the cases where the fire resistant glazing assemblies do not need the same functions on both sides.

### EXAMPLE 3

A glazing assembly was made in accordance with FIG. 3. Material 1 and 2 were two pieces of 4 mm soda-lime float glass. Material 3 was a piece of solar control window film. Material 5 was a 5 mm waterglass based intumescent interlayer. The glazing assembly achieved more than 20 minutes fire integrity, and could greatly reduce solar heat gain through the glazing assembly.

FIG. 4 depicts an embodiment that has an unsymmetrical structure containing three glass sheets, one plastic film and two intumescent interlayers. Material 1, 2 and 7 are soda-lime glass sheets. Material 3 is plastic film having certain specific functions; it is adhered onto the surface of glass sheet 1. Material 5 is an intumescent interlayer; it is between glass sheet 1 and 7, and bonds with plastic film 3 and glass sheet 7. Material 6 is another intumescent interlayer; it is between glass sheet 2 and 7, and bonds with glass sheet 2 and 7.

This embodiment is a complication of the embodiment depicted in FIG. 3; it has the two intumescent interlayers. The further complication can have more intumescent interlayers.

### EXAMPLE 4

A glazing assembly was made in accordance with FIG. 4. Material 1 and 2 were two pieces of 4 mm soda-lime float glass; material 7 was a piece of 3 mm soda-lime float glass. Material 3 was a piece of decorative window films. Material 5 and 6 were 5 mm waterglass based intumescent interlayers. The glazing assembly achieved 45 minutes fire integrity and fire insulation, and the decoration purpose.

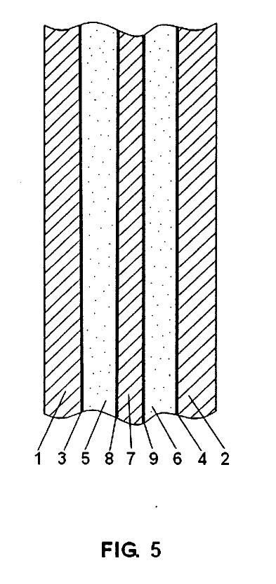

FIG. 5 depicts an embodiment that has a symmetrical structure containing three glass sheets, four plastic films and two intumescent interlayers. Material 1, 2 and 7 are soda-lime glass sheets. Material 3, 4, 8 and 9 are plastic films having certain specific functions; they are respectively adhered onto the opposite surfaces of glass sheet 1, 2 and 7. Material 5 is an intumescent interlayer; it is between glass sheet 1 and 7, and bonds with plastic film 3 and 8. Material 6 is another intumescent interlayer; it is between glass sheet 2 and 7, and bonds with plastic film 4 and 9.

This embodiment is especially suitable for the cases where the fire resistant glazing assemblies need high structural strength. For example, when plastic film 3, 4, 8 and 9 adopt security window films, the glazing assembly can achieve the additional functions in bullet and blast resistance. The further complication of this embodiment can have more intumescent interlayers.

### EXAMPLE 5

A glazing assembly was made in accordance with FIG. 5. Material 1 and 2 were two pieces of 5 mm soda-lime laminated glass; material 7 was a piece of 3 mm soda-lime float glass. Material 3, 4 were two pieces of 0.2 mm security window films. Material 8 and 9 were two pieces of 0.1 mm safety window films. Material 5 and 6 were 5 mm hydrogel intumescent interlayers. The glazing assembly achieved 45 minutes fire integrity and fire insulation, UL 752 level-3 bullet resistance, and more than 46 dB sound insulation.

The foregoing descriptions of preferred embodiments of the present invention have been presented for purposes of illustration and description only. They are not intended to be exhaustive or to limit the present invention. Accordingly, many modifications or variations will be possible in light of the above teaching. The scope of the present invention is defined by the appended claims.

I claim:

1. A fire resistant glazing assembly with additional functions, comprising: a) two or more glass sheets that are parallel and spaced-apart from each other, the distance between any two adjacent glass sheets is from 1 mm to 40 mm; b) one plastic film that is adhered onto one of opposite surfaces of the glass sheets or more plastic films that are respectively adhered onto more opposite surfaces of the glass sheets; c) one or more intumescent interlayers that are between the glass sheets and bond with the glass sheet or the plastic film adhered onto the glass sheet, wherein the plastic film is compatible with fire resistant glazing assembly and has at least one specific function in safety and security, solar control, decoration and aesthetics, privacy protection, sound insulation and signal defense security.

2. The fire resistant glazing assembly of claim 1, wherein said glass sheet is soda-lime glass sheet.

3. The fire resistant glazing assembly of claim 1, wherein said glass sheet is annealed, tempered, strengthened or laminated glass sheet.

4. The fire resistant glazing assembly of claim 1, wherein said glass sheet is achromatous or tinted.

5. The fire resistant glazing assembly of claim 1, wherein said glass sheet has original surface or treated surface.

6. The fire resistant glazing assembly of claim 5, wherein said treated surface is coated, painted, patterned, etched, or sandblasted surface.

7. The fire resistant glazing assembly of claim 1, wherein said plastic film is either commercialized window film or original plastic film.

8. The fire resistant glazing assembly of claim 1, wherein said plastic films in a fire resistant glazing assembly are either the same film or different films.

9. The fire resistant glazing assembly of claim 1, wherein said plastic film is treated by surface treatment techniques.

10. The fire resistant glazing assembly of claim 9, wherein said surface treatment techniques are coating, chemical grafting and corona discharging.

11. The fire resistant glazing assembly of claim 1, wherein said plastic film is adhered onto surface of the glass sheet with adhesive.

12. The fire resistant glazing assembly of claim 11, wherein said adhesive is either acrylic adhesive or silicone adhesive.

13. A method of manufacturing a fire resistant glazing assembly with additional functions, comprising the steps: adhering the plastic film(s) onto surface(s) of the glass sheet(s) and bonding the glass sheets and intumescent interlayer(s) together in the form of the film(s) existing inside the glazing assembly.
